(19) United States
(12) Patent Application Publication
(10) Pub. No.: US 2026/0064485 A1
(43) Pub. Date: Mar. 5, 2026

(54) ALLOCATING COMPUTING RESOURCES TO WORKLOADS

(71) Applicant: Hewlett Packard Enterprise Devopment LP, Spring, TX (US)

(72) Inventors: Gernot Seidler, San Jose, CA (US); Srujana Reddy Attunuri, San Jose, CA (US); Abhishek Kumar Agarwal, Jersey City, NJ (US)

(21) Appl. No.: 18/824,776

(22) Filed: Sep. 4, 2024

(51) Int. Cl. G06F 9/50

(52) U.S. Cl. CPC G06F 9/505; G06F 9/5038; G06F 9/5072; G06F 2209/5014; G06F 2209/504; G06F 2209/505

(57) ABSTRACT

In certain implementations, a computing device includes a processor and a non-transitory computer-readable storage media storing programming for execution by the processor. The programming includes instructions to receive a request to schedule a computing workload and determine a resource type and requested resource amount for the computing workload. The programming includes instructions to obtain a total licensed capacity for the resource type, and obtain a current resource usage across existing computing workloads for the resource type. The programming includes instructions to determine whether scheduling the computing workload would cause total resource usage to exceed the total licensed capacity, and to approve, based at least on determining that the total resource usage would not exceed the total licensed capacity, the computing workload for scheduling, or to queue, based at least on determining that the total resource usage would exceed the total licensed capacity, the computing workload for later scheduling.

### BACKGROUND

Modern computing environments often include complex arrangements for managing the scheduling and deployment of computing workloads. For example, these computing environments may include cloud computing environments, on-premises computing environments, hybrid-cloud computing environments, or other types of distributed computing environments. These computing environments may include capabilities that allow users to adjust the scale of computing resource usage according to computing workload demands.

### BRIEF DESCRIPTION OF THE DRAWINGS

For a more complete understanding of this disclosure, and advantages thereof, reference is now made to the following descriptions taken in conjunction with the accompanying drawings, in which:

FIG. 1 illustrates an example system for allocating computing resources to workloads, according to certain implementations;

FIG. 2 illustrates an overview of an example workload evaluation process performed by scheduler, according to certain implementations;

FIG. 3 illustrates an example method for allocating computing resources to workloads, according to certain implementations;

FIG. 4 illustrates an example method for allocating computing resources to workloads, according to certain implementations;

FIG. 5 illustrates an example method for identifying candidate compute nodes and determining associated computing resource allocation amounts, according to certain implementations;

FIG. 6 illustrates an example method for allocating computing resources to workloads, according to certain implementations;

FIG. 7 illustrates an example computing resource allocation scenarios and associated example license considerations, according to certain implementations;

FIG. 8 illustrates an example computing resource allocation scenarios and associated example license considerations, according to certain implementations; and

FIG. 9 illustrates a block diagram of an example computing device, according to certain implementations.

### DESCRIPTION

Computing resources, such as software, services, physical infrastructure, virtual infrastructure, as examples, may be commercialized in various ways, including paid-up, perpetual licenses and subscription-based licenses. License enforcement refers to mechanisms used to manage license compliance. Software licensing plays a role in managing access to and use of various software applications and resources. In container orchestration environments, for example, different licensing models may be used to license resources for management and execution of applications and frameworks. Two license models include the term-capacity model and the consumption model.

The term-capacity model may be based on a fixed term (e.g., one, three, or five years) and tied to an amount (capacity) of one or more types of system resources. The amount of system resources could include, as examples, a number of CPU cores, CPUs, or graphics processing units (GPUs, which may include logical GPUs (IoGPUs) and/or physical GPUs (GPUs or pGPUs)), or an amount of storage. With the term-capacity model, customers buy licenses for their entire system capacity, regardless of actual usage. With some implementations, a customer can add capacity either by purchasing additional licensing capacity or freeing up unused resources held by other applications and/or frameworks.

The consumption model may involve a customer paying for a certain amount of resource usage for a time period (e.g., CPU hours per month), and paying an overage fee if the customer exceeds this amount. The capacity model is somewhat like a cell phone plan in which a customer buys a particular number of minutes per month up front, and if the actual minutes used in a particular month exceeds the particular number of minutes, the customer must pay for the additional minutes, possibly at a heightened rate.

These licensing models may present one or more problems. For example, tying software license terms to static resource capacities (e.g., a number of CPU cores or a particular storage capacity) or usage that is determined up front may be inflexible and lead companies to purchase licenses based on maximum potential capacity/usage. Modern computing environments provide an ability to scale computing resources to accommodate actual computing workload demands. For example, the rise of cloud computing and containerized applications has changed how software and computing resources are deployed and utilized. These distributed environments offer flexibility, allowing organizations to scale their resources up or down rapidly in response to changing demands. This dynamic nature of cloud computing environments presents new challenges for software licensing models. For example, the dynamic nature of these cloud computing environments complicates prediction of resource capacity and/or usage, often leading customers to purchase licenses for the maximum anticipated capacity. Traditional licensing models may charge customers for the total capacity of their infrastructure, including overhead resources required to run the container orchestration platform, rather than just the resources used by the customer's actual workloads. This can result in customers paying for more capacity than they actively use, frustrating parties by the inability of these licensing models to adapt to the fluid nature of cloud and containerized environments. As another example, these licensing models may charge licensees for total infrastructure capacity rather than just resources used by customer workloads. As another example, traditional licensing techniques may lack granular licensing options for different types of workloads or resources.

Certain implementations of this disclosure provide an automated and computer-implemented licensing system that can track computing resource usage in real-time, enforce license terms dynamically, and with minimal or no impact on the performance or flexibility of cloud-native applications. Certain implementations are capable of addressing licensing concerns for various types of computing resources, from traditional CPU cores to more specialized hardware like GPUs, each of which may have its own licensing considerations.

Certain implementations of this disclosure provide a dynamic software license enforcement system for cloud environments. Certain implementations decouple licensing from total infrastructure capacity. Certain implementations attempt to tie licenses to actual workload resource usage. Certain implementations provide a custom scheduler that enforces license terms when scheduling workloads. Certain implementations provide an ability to categorize different types of workloads and resources for more granular licensing. Certain implementations provide for dynamic tracking of resource usage across workloads to attempt to stay within license limits. Certain implementations queue workloads that would exceed license capacity until license capacity becomes available by freeing up used resources or adding additional license capacity. Certain implementations support different resource types like vCPUs and GPUs, including fractional GPU usage.

Certain implementations can integrate with container orchestration platforms like KUBERNETES, using a custom scheduler plugin to enforce licensing at the workload scheduling stage. Certain implementations track resource usage across running and pending workloads, comparing against purchased license capacity before allowing new workloads to run.

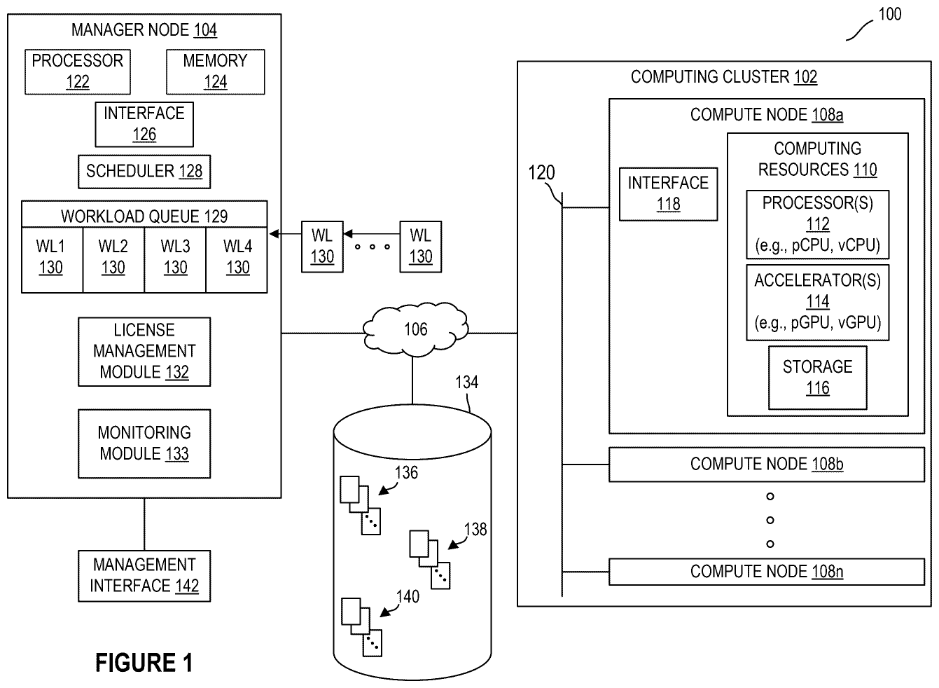

Turning to the figures, FIG. 1 illustrates an example system 100 for allocating computing resources to workloads, according to certain implementations. Computing system 100 may be part of a computing environment, such as a containerization environment, a virtualization environment, an HPC environment, a cloud environment, an on-premise environment, or a hybrid cloud environment, some of which may overlap in type. In some implementations, computing system 100 is capable of parallel execution of computing processes, such as tasks of a workload. In the illustrated example, system 100 includes a computing cluster 102, a manager node 104, and network 106. Although this implementation of system 100 is illustrated and described, this disclosure contemplates system 100 being implemented in any suitable manner, according to particular needs.

Computing cluster 102 includes one or more compute nodes 108, shown as compute nodes 108a, 108b, and through 108n. Compute nodes 108a, 108b, and 108n may be referred to generally as compute node 108 or compute nodes 108. In certain implementations, compute nodes 108 may work together to perform processing operations, such as cluster operations, HPC operations, and/or other suitable types of computing operations. For example, a workload (e.g., workloads 130, described below) may be divided into smaller segments or tasks that may be parallelized across compute nodes 108. Process(es) may be executed on compute nodes 108 to perform the processing operations associated with the workload. Compute nodes 108 may be implemented using any suitable combination of hardware, firmware, and software. For example, each compute node 108 may be a standalone unit equipped with a processor, memory, and the like (subsequently described), which may be physical or virtual and/or local/distributed.

A workload, which also may be referred to as a computing workload, may include a collection of one or more electronic processing tasks organized in any suitable manner. For example, a workload may include, or be a portion of, one or more software applications, one or more containers, one or more KUBERNETES pods, one or more virtual machines, batch jobs or batch processing tasks, continuous integration/continuous development (CI/CD) pipelines, serverless functions or Function-as-a-service (FaaS) instances, KServe endpoints, notebooks (e.g., JUPYTER), machine learning tasks (e.g., training and/or use tasks), inference tasks for deployed artificial intelligence (AI) models, data analytics jobs (e.g., SPARK jobs), HPC simulations, database instances or database operations, stream processing tasks, web servers, application servers, microservices, distributed ledger or blockchain tasks, and/or any other suitable types of processing tasks, some of which may overlap in type.

A workload may be executed using one or more compute nodes 108, which execute processing tasks, such as tasks of a workload for execution in a potentially parallel manner. For example, these processing tasks may be assigned to compute nodes 108 (e.g., by manager node 104) as execution flows that involve compute nodes 108 executing computer code, potentially in portions. To that end, compute nodes 108 may execute one or more processes of the workload, working together to execute the workload.

Additional details of one compute node 108 (compute node 108a, in the illustrated example) are shown, but this disclosure will continue to refer to compute node 108 generally as compute node 108. Compute node 108 includes various computing resources 110. Computing resources 110 may include one or more processors 112, one or more accelerators 114, storage 116, and/or any other suitable computing resources 110.

Processors 112 may be any suitable combination of central processing units, microprocessors, ASICs, microcontrollers, or the like, some of which may overlap in type. Although referred to in the plural, processors 112 may include one or more processors (potentially of varying types) at one or more locations. Processors 112 may include physical processors (e.g., pCPUs) and/or virtual processors (e.g., vCPUs). Although this disclosure primarily describes CPUs, this disclosure contemplates processors 112 including any suitable types of processors, alone or in combination.

Accelerators 114 may include specialized processing devices that can perform one or more processing tasks, such as those processing tasks that may be associated with certain types of workloads. Examples of accelerators 114 may include GPU devices, ASIC devices, FPGA devices, vision processing unit (VPU) devices, neural processing unit (NPU) devices, tensor processing unit (TPU) devices, and/or other types of specialized processing devices that may be incorporated into or otherwise accessible to a compute node 108 to expedite computations for workloads. An accelerator 114 may provide significant computational power, allowing for faster execution of some tasks than a general-purpose processor (e.g., a processor 112). Accelerators 114 may include physical accelerators (e.g., pGPUs)) and/or virtual accelerators (e.g., IoGPUs). Examples of IoGPUs may include virtual GPUs (vGPUs), partial GPUs, and/or other suitable types of partitioned GPUs. Although this disclosure primarily describes GPUs, this disclosure contemplates accelerators 114 including any suitable types of accelerators, alone or in combination.

Storage 116 may include various types of memory, including volatile and nonvolatile memory. For example, storage 116 may include Random-Access Memory (RAM), Read-Only Memory (ROM), a Hard Disk Drive (HDD), and/or the like. Different types of memory may be used for different data storage needs. For example, processor 112 may boot from ROM, maintain nonvolatile storage in an HDD, execute program code stored in RAM, and store data under processing in RAM. In certain implementations, a portion or all of storage 116 may be or include a database, such as one or more structured query language (SQL) servers or relational databases. Storage 116 may include a non-transitory computer readable medium that stores instructions for execution by processor 112. One or more modules within compute node 108 may be partially or wholly embodied as software and/or hardware for performing any functionality described herein. Although referred to in the singular, storage 116 may be multiple storage devices at one or more locations.

Compute nodes 108 may include an interface 118, which may be used to connect to network 106 (e.g., to communicate with manager node 104 and/or other suitable entities) and/or to connect to link 120 to communicate with other compute nodes 108 in computing cluster 102. Interface 118 may adhere to one or more networking standards such as Ethernet, Wi-Fi, and the like. Although referred to in the singular, interface 118 may be multiple interfaces. Link 120 may adhere to one or more networking standards such as Ethernet, Wi-Fi, and the like. Although referred to in the singular, link 120 may be multiple links. The design of at least a portion of link 120 may prioritize low latency and high throughput among the connected components. For example, some or all of link 120 may be based on a technology such as Ethernet, InfiniBand, or the like.

Compute nodes 108 (e.g., compute nodes 108a through 108n) might or might not be similar to each other. For example, certain compute nodes 108 might include different computing resources 110 than other compute nodes 108. As a particular example, certain compute nodes 108 might include one or more accelerators 114, while other compute nodes 108 lack accelerators 114. As another particular example, certain compute nodes 108 might include different numbers of processors 112, accelerators 114, and storage 116 than other compute nodes 108. In yet another particular example, some or all of compute nodes 108 might be configured with essentially identical computing resources 110.

Manager node 104 may be responsible for managing computing cluster 102, including compute nodes 108 within which the components of the computing cluster 102 are configured to perform a requested workload. Although shown to be outside computing cluster 102, manager node 104 could be located within computing cluster 102, such as being one of the compute nodes of computer cluster 102. Manager node 104 may be an entry point of administrative tasks for the computing cluster 102 and may be responsible for orchestrating compute nodes 108 of computing cluster 102.

Manager node 104 includes a processor 122, a memory 124, and an interface 126. Processor 122 retrieves executable code from memory 124 and executes the executable code. The executable code may, when executed by processor 122, cause processor 122 to implement any functionality described herein. Processor 122 may be a microprocessor, an application-specific integrated circuit, a microcontroller, or the like. Although referred to in the singular, processor 122 may be multiple processors at one or more locations.

Memory 124 may include various types of memory, including volatile and nonvolatile memory. For example, memory 124 may include RAM, ROM, an HDD, and/or the like. Different types of memory may be used for different data storage needs. For example, processor 122 may boot from ROM, maintain nonvolatile storage in an HDD, execute program code stored in RAM, and store data under processing in RAM. In certain implementations, a portion or all of memory 124 may be or include a database, such as one or more SQL servers or relational databases. Memory 124 may include a non-transitory computer readable medium that stores instructions for execution by processor 122. One or more modules within manager node 104 may be partially or wholly embodied as software and/or hardware for performing any functionality described herein. Although referred to in the singular, memory 124 may be multiple memory devices at one or more locations.

Interface 126 may be used to connect to network 106 and communicate with other nodes over network 106. Interface 126 facilitates the transmission and reception of data packets between manager node 104 and compute nodes 108 (e.g., via network 106), and may adhere to one or more networking standards such as Ethernet, Wi-Fi, and the like. Although referred to in the singular, interface 126 may be multiple interfaces.

Network 106 may be any suitable type of communication network for electronic devices, and may facilitate wired and/or wireless communication. Network 106 may communicate, for example, IP packets, Frame Relay frames, ATM cells, voice, video, data, and other suitable information between network addresses. Network 106 may include any suitable combination of one or more local area networks (LANs), radio access networks (RANs), metropolitan area networks (MANs), wide area networks (WANs), mobile networks (e.g., using WiMax (802.16), WiFi (802.11), 3G, 4G, 5G, or any other suitable wireless technologies in any suitable combination), all or a portion of the global communication network known as the Internet, and/or any other communication system or systems at one or more locations, any of which may be any suitable combination of wireless and wired. Network 106 may include controllers, APs, switches, routers, firewalls, or the like for forwarding traffic.

Manager node 104 includes a scheduler 128. Scheduler 128 receives or otherwise accesses workloads (now referred to as workloads 130) and schedules workloads 130 for deployment to one or more compute nodes 108 of computing cluster 102 for executing using computing resources 110 of the one or more compute nodes 108. Scheduler 128 may have access to information regarding available computing resources 110 of computing cluster 102, as well as computing resources 110 used for the applications to run. This information may be used by scheduler 128 to make decisions about where to deploy workloads 130.

For example, scheduler 128 may include or otherwise have access to a workload queue 129 that receives and stores workloads 130 that are in a pending state awaiting allocation of computing resources 110 of compute nodes 108 and associated deployment for execution. For example, the pending workloads 130 may be waiting in workload queue 129 (or another suitable type of data structure) for computing resources 110 to become available for allocating to the pending workload 130, for licensing constraints to be met (as described in greater detail below), or for other suitable reasons. Workloads 130 are sometimes abbreviated as “WL,” possibly with a number (as in “WL #”), as is the case with workload queue 129 of FIG. 1.

A workloads 130 may be scheduled based on a variety of factors, including parameters requested in workload 130, the states and capabilities of compute nodes 108, the availability of computing resources 110 at compute nodes 108, the ability to meet licensing constraints using available computing resources 110 at available compute nodes 108, and/or on a variety of other factors. Manager node 104 may monitor the states and capabilities of compute nodes 108 (e.g., compute utilization, memory utilization, etc.) and make workload scheduling decisions based at least in part on the states and capabilities of compute nodes 108.

It may be possible to process certain workloads 130, in whole or in part, using one or more combinations of computing resources 110 of compute nodes 108. For example, some workloads 130 may be adequately processed using processors 112, while other workloads 130 may request extensive use of accelerators 114. Certain workloads 130 may specifically request processing using one or more accelerators 114, certain workloads 130 may allow for processing using one or more accelerators 114, and still other workloads 130 may be configured as not suitable for processing using one or more accelerators 114. Manager node 104 may attempt to allocate one or more computing resources 110 to workloads 130 to facilitate processing those workloads 130 according to the parameters of the workloads 130.

As described above, entities that intend to use system 100 to process workloads 130 may obtain one or more software licenses to make use of system 100 and some or all of the services offered by system 100. For example, software licenses may be offered by an entity who provides management services (and possibly physical infrastructure) for system 100. Those management services may include software that runs within system 100 to manage the provision of services, such as managing clusters, scheduling workloads, and many other associated features. As a particular example, the software may include container orchestration platform.

Manager node 104 may include a license management module 132. License management module 132 may receive the licenses obtained by users of system 100, store those licenses as licenses 136 in a storage device 134. For example, licenses 136 may include copies of the software licenses held by entities (e.g., licensees, customers, or the like) that use services provided by system 100. In certain implementation, license management module 132 may facilitate interaction with users of system 100 (e.g., via management interface 142, described below) to obtain, update, amend, etc. one or more licenses 136.

Storage device 134 may include various types of memory, including volatile and nonvolatile memory. For example, storage device 134 may include RAM, ROM, an HDD, and/or the like. In certain implementations, a portion or all of storage device 134 may be or include a database, such as one or more SQL servers or relational databases. Although referred to in the singular, storage device 134 may be multiple storage devices at one or more locations. Although illustrated separately from manager node 104, manager node 104 may include storage device 134 in certain implementations (e.g., as part of memory 124).

According to certain implementations, a licenses 136 may include one or more license terms related to a licensee's ability to execute software using computing resources 110 of compute nodes 108 of computing cluster 102. The license terms may correspond to one or more license term categories that provide granular control over the terms of the license 136, and allow license 136 to be tailored to particular use cases for licensees.

According to certain implementations, the license terms categories may include one or more of resource type, framework type, application type, vendor type, and/or any other suitable categories. For example, a resource type may include a type of computing resource 110 that is being licensed, examples of which may include pCPU, vCPU, pGPU, IoGPU, etc. As another example, a framework type may include a type of framework that is being licensed. A framework may include a structured platform that provides tools to manage clusters, containers, microservices, and/or other features, and different frameworks may be available from different vendors. Some example frameworks may include KUBERNETES, KUBEFLOW, SPARK, LIVY, RAY, user-provided frameworks, and/or any other suitable types of frameworks. As another example, an application type may include the type of application that the licensee intends to run using system 100, as distinguishable from the framework that may be used to run those applications. As another example, the vendor type may be the vendor of the framework, application, or other component that the licensee intends to run using system 100. For example, some components may be provided by the operator of system 100, some components may be provided by third-party vendors, or some components may be provided by the licensee, and license 136 may be categorized according to the vendor. In certain implementations, the license term categories may be arranged and/or available in a category/subcategory relationship. For example, a license 136 may be specific to a particular framework and may further be specific to a particular resource type for use with that framework.

License 136 also may specify a resource amount (e.g., capacities) for one or more of the license term categories/subcategories associated with license 136. A resource amount for a license 136 may be tied to a at least one license term category, a license term category-subcategory combination, or the like. For example, a license 136 may specify a resource type of pCPU with a resource amount of 100 units, and may also specify a resource type of IoGPU with a resource amount of 50 units. As another example, a license 136 may specify a resource type of pCPU with a resource amount of 100 units, and not include a license for any GPUs (pGPUs or IoGPUs), as the licensee may not anticipate using any GPU resources for their workloads 130. As another example, a particular license 136 may specify a first framework and for the first framework a first resource type of vCPU with a resource amount of 100 units and second resource type of IoGPU with a resource amount of 50 units. The particular license also may specify a second framework and for the second framework a first resource type of vCPU with a resource amount of 50 units and second resource type of IoGPU with a resource amount of 75 units.

A licensor may establish which license term categories are to be active/enforced, either universally or for particular licensees. In other words, the licensor may establish where granularity in license terms will be allowed, by permitting the licensee to establish particular values for the license terms.

The above provides just a few examples of the types of combinations of license term categories/subcategories that are available due to licenses 136 being offered with multiple license term categories/subcategories and associated resource amounts. This ability to select license term categories/subcategories and associated resource amounts may offer a heightened level of granularity to licensees (e.g., the entity purchasing the license 136 and using the software/service), so that licensees can tailor the license to the particular objectives and use cases of the licensee. This ability to select license term categories/subcategories and associated resource amounts may offer a heightened level of granularity to licensors (e.g., the entity selling the license 136 and providing the software/service), so that licensors can tailor license terms at a more granular level. Furthermore, as described in greater detail below, the ability to establish license terms at a level of license term categories/subcategories and associated resource amounts may allow scheduler 128 to determine categories of workloads 130 according to parameters of workloads 130, and to correlate those categories of workloads 130 to particular license terms. This approach may provide improved licensing flexibility, potentially better cost optimization for licensee, and the ability for software vendors to create more nuanced licensing models. This approach may provide a more dynamic, usage-specific approach that can adapt to the varied and changing needs of modern cloud and containerized environments.

Continuing with license management module 132, license management module 132 may be configured to generate license information 138 (e.g., to be stored in storage device 134) by analyzing licenses 136 to extract particular information from licenses 136, and associate particular usage information with license terms so that the information can be used by scheduler 128 to make scheduling decisions for workloads 130. License information 138 may include any suitable information determined from licenses 136. In certain implementations, license information 138 may include information regarding particular license terms of licenses 136 arranged in a more manageable and accessible way. For example, license information 138 may include information regarding one or more license term categories and associate resource amounts (e.g., capacities), if applicable. As particular examples, license information 138 may specify one or more types of computing resources 110 (e.g., pCPUs, vCPUs, pGPUs, IoGPUs, etc.), along with corresponding resource amounts (e.g., capacities). As another example, license information 138 may include information regarding one or more frameworks and, for each framework, one or more resource amounts for one or more different resource types (e.g., pCPUs, vCPUs, pGPUs, IoGPUs, etc.).

Manager node 104 may include a monitoring module 133, which may obtain or otherwise determine usage information and store the usage information as usage information 140 in storage device 134. Usage information 140 may include information regarding the current inventory, topology, status, and/or other details of computing cluster 102, compute nodes 108 of computing cluster 102, and computing resources 110 of compute nodes 108. Usage information 140 may include current resource usage across existing computing workloads 130 for each type of computing resource 110. In other words, for one or more types of computing resources 110, usage information 140 may include current allocations of computing resources 110 to existing workloads 130. Usage information 140 may include current utilization information of computing resources 110 such that scheduler 128 can determine which computing resources 110 are already allocated to workloads 130 (regardless of licensee) and which computing resources are available.

Some or all of usage information 140 may be stored on a per licensee basis, so that scheduler 128 can access a particular licensee's usage information 140 when evaluating licensing conditions associated with scheduling workloads 130. For example, usage information 140 for a particular licensee may include, for one or more types of computing resources 110, information regarding the amount of the computing resource 110 that is current allocated to workloads 130 of the licensee.

In certain implementations, some or all of usage information 140 is retrieved and stored as time series data in storage device 134. For example, some or all of storage device 134 may be implemented as a PROMETHEUS or other suitable type of database that is configured to collect usage information 140, from computing resources 110, compute nodes 108, computing cluster 102, and/or monitoring module 133 at a regular or irregular interval.

Although this disclosure describes a particular division of operations between scheduler 128, license management module 132, and monitoring module 133, this disclosure contemplates any suitable division of operations, including a single entity (e.g., scheduler 128) performing all of the operations described with reference to these components. Additionally, scheduler 128, license management module 132, and monitoring module 133 may be implemented using any suitable combination of hardware, firmware, and software.

As described above, as part of scheduling workloads 130 for allocation of one or more computing resources 110, scheduler 128 may determine whether allocating the requested computing resources 110 to the workload 130 complies with a license associated with workload 130 (e.g., with an entity submitting workload 130). Scheduler 128 may receive a request to schedule a workload 130, which also may be considered simply obtaining a workload 130 from a workload queue 129 or other suitable source. The request and/or workload 130 may be associated with an entity (e.g., a customer) that may hold one or more licenses 136 associated with using computing system 100.

The request and/or workload 130 may include one or more parameters that can be used to determine whether allocating the requested computing resources 110 to the workload 130 complies with a license 136 associated with workload 130. A license 136 associated with a workload 130 may refer to a license 136 associated with a licensee (e.g., an entity) submitting workload 130 for processing using system 100. The one or more parameters may include an indication of one or more categories and associated resource amounts, where applicable, for workload 130. Some or all of the categories of certain parameters may correspond to license term categories that are available to be specified for license 136. In certain implementations, the parameters may include resource type, framework type, application type, vendor type, and/or any other suitable categories, along with associated resource amounts, where appropriate.

For example, the parameters may include information for determining one or more computing resource types and corresponding computing resource amounts associated with workload 130 and requested to be allocated to workload 130 for executing workload 130 using one or more compute nodes 108 of computing cluster 102. A resource type may include a type of computing resource 110 that is being requested for workload 130, examples of which may include pCPU, vCPU, pGPU, IoGPU, etc. As another example, a framework type may include a type of framework associated with workload 130. Some example frameworks are described above in connection with possible license terms. As another example, an application type may include the type of application that the licensee intends to run using system 100, as distinguishable from the framework that may be used to run those applications. As another example, the vendor type may be the vendor of the framework, application, or other component that the licensee intends to run using system 100. For example, some components may be provided by the operator of system 100, some components may be provided by third-party vendors, or some components may be provided by the licensee, and workload 130 may be categorized according to the vendor. In certain implementations, the categories of parameters may be arranged and/or available in a category/subcategory relationship. For example, a workload 130 may be specific to a particular framework and may further be specific to a particular resource type for use with that framework.

Workload 130 also may specify a resource amount for one or more of the categories/subcategories associated with the workload 130. A resource amount for a workload 130 may be tied to a category, a category-subcategory combination, or the like. For example, a workload 130 may specify a resource type of pCPU with a resource amount of 5 units, and may also specify a resource type of IoGPU with a resource amount of 2 units. As another example, a workload 130 may specify a resource type of pCPU with a resource amount of 10 units, and not include a request any GPUs (pGPUs or IoGPUs). As another example, a workload 130 may specify a first framework and for the first framework a first resource type of vCPU with a resource amount of 20 units. The above provides just a few examples of the types of combinations that are available for workloads 130.

Scheduler 128 may attempt to schedule workload 130 according to the one or more parameters of workload 130. In connection with attempting to schedule workload 130 according to the one or more parameters of workload 130, scheduler 128 may determine whether allocating workload 130 computing resources 110 from particular compute nodes 108 complies with a license 136 associated with workload 130. To that end, scheduler 128 may evaluate license constraints specific to one or more parameters of workload 130.

To evaluate workload 130 to determine whether to approve or deny scheduling of workload 130 according to the license constraints associated with a license 136 associated with workload 130, scheduler 128 may obtain certain information that may be used by workload license evaluation engine 202 to perform the evaluation. For example, scheduler 128 may determine the requested computing resources 110 and associated resource amounts from the request and/or workload 130. As another example, scheduler 128 may obtain selected portions of license information 138 and usage information 140.

As an example, the one or more parameters of workload 130 may identify one or more resource types of computing resources 110 that are requested to be used to process workload 130. The one or more parameters of workload 130 may identify corresponding resource amounts for the one or more resource types of computing resources 110 that are requested to be used to process workload 130. Scheduler 128 may obtain (e.g., from usage information 140), for the licensee associated with workload 130, a current resource usage across existing workloads 130 for one or more resource types for workload 130. Scheduler 128 may obtain (e.g., from license information 138) total licensed capacities for the one or more resource types associated with workload 130.

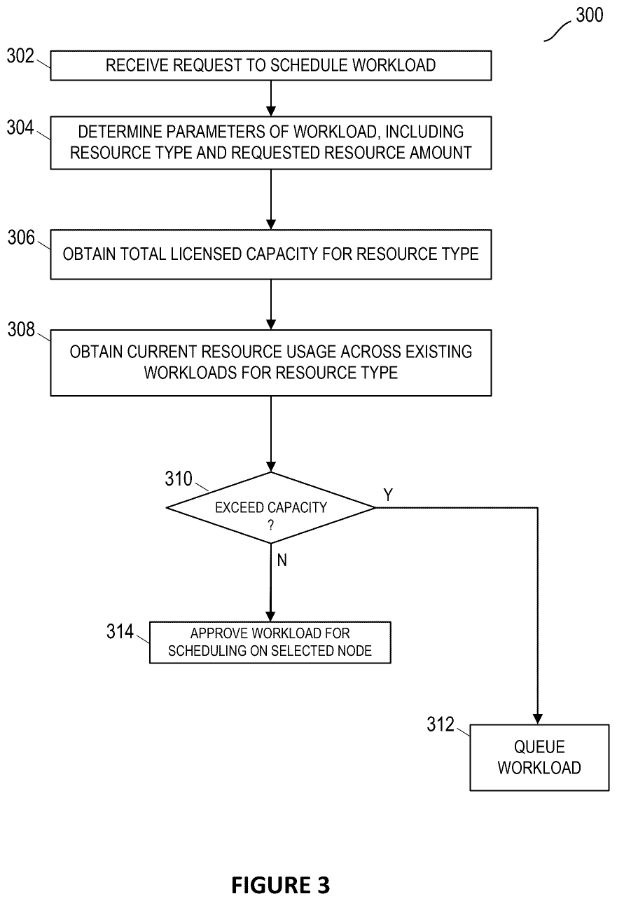

Based on the information determined from workload 130 (and/or an associated request to schedule workload 130), license information 138, and usage information 140, scheduler 128 may determine, for the licensee associated with workload 130, whether scheduling workload 130 would cause total resource usage to exceed the total licensed capacity. Additional details regarding the particular determinations made by scheduler 128 (e.g., workload license evaluation engine 202) are described in greater detail below with reference to FIGS. 3-8.

If workload license evaluation engine 202 determines that the licensee lacks sufficient available computing resources 110 for processing workload 130 (e.g., workload 130 is not approved), then scheduler 128 may return workload 130 to workload queue 129 for reconsideration at a future time. If workload license evaluation engine 202 determines that the licensee has sufficient available computing resources 110 for processing workload 130 (e.g., workload 130 is approved), then scheduler 128 may allocate computing resources 110 to workload 130 and schedule workload 130 for deployment to one or more compute nodes 108 of computing cluster 102.

In certain implementations, scheduler 128 may identify the licensee for a particular workload 130, and may access license information 138 for the particular licensee to determine which license term categories are active for that licensee. To the extent multiple licensed term categories are active for the licensee, scheduler 128 may evaluate multiple license term categories and associated workload parameters to determine whether to allow or deny scheduling of workload 130. As just one example, license information 138 for a particular licensee may indicate that both CPU and GPU license constraints are defined by the license 136 for the particular licensee. Thus, in determining whether allow or deny scheduling of a workload 130 for that licensee, scheduler 128 may evaluate both CPU and GPU values associated with workload 130.

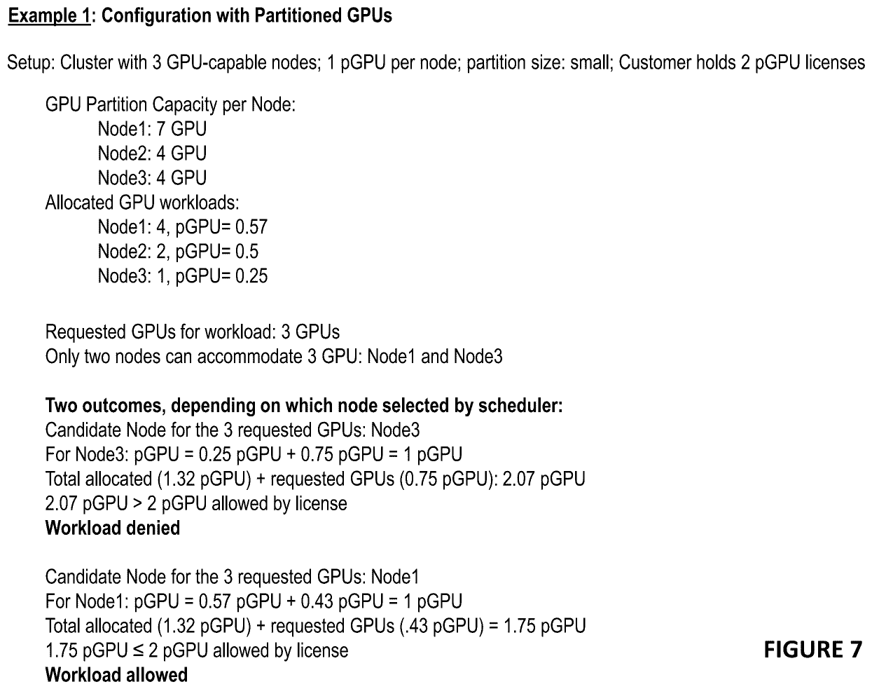

Certain implementations of scheduler 128 provide an ability to attempt to determine an optimum allocation of computing resources 110 that comply with license constraints. For example, a first compute node 108 may have adequate available computing resources 110 for allocation to workload 130; however, allocating the computing resources 110 from the first compute node 108 to workload 130 may cause the total allocated resources for the licensee associated with workload 130 to exceed the license terms. A second compute node 108 also may have adequate available computing resources 110 for allocation to workload 130, but allocating the computing resources 110 from the second compute node 108 may result in a total allocated resources for the licensee that remains within the license term. An example of such a scenario is described in greater detail below with reference to FIG. 7, Example 1. Scheduler 128 may be able to identify from a number of possible compute nodes 108 that could process a workload 130 a particular compute node 108 that can do so within the limits established by a license 136 of licensee.

In certain implementations, scheduler 128 may be implemented as a standalone scheduler or a plugin to another scheduler. For example, scheduler 128 may be implemented as a standalone scheduler that includes standard scheduling functionality along with the functionality described herein. As another example, scheduler 128 may be implemented as a plugin that can be deployed alongside a default scheduler to provide the functionality described herein. The default scheduler may be a scheduler that provides default scheduling functions associated with the computing environment (e.g., computing system 100 of FIG. 1), such as a scheduler provided by a container orchestration platform/framework upon which computing system 100 (see FIG. 1) operates. As just one example, the default scheduler could be a KUBERNETES scheduler that provides scheduling operations within the context of a KUBERNETES system. In certain implementations, the scheduler plugin integrates with a Permit phase of the KUBERNETES scheduling lifecycle.

In certain implantations, computing system 100 may include a management interface 142, which may be used to control manager node 104, among other elements of computing system 100, if appropriate. A system administrator or other suitable human or machine user may access manager node 104 using management interface 142. Management interface 142 may be a central point of access for manager node 104, which is accessible from a public computer network such as the internet. Manager node 104 may receive commands via management interface 142. Manager node 104 may process the commands from management interface 142, validate the commands, and execute logic specified by the commands. Further, manager node 104 may output the results of commands via management interface 142. Examples of management interface 142 include a command line interface, a graphical user interface, a web interface, or the like.

In certain implementations, management interface 142 may display information about workloads 130 and the use of computer resources 110 to process those workloads 130. For example, management interface 142 may allow a system administrator to observe the amount of licensed computing resources 110, the amount of licensed computing resources 110 being used to process workloads 130, the amount of licensed computing resources 110 available for processing workloads 130, and/or any other suitable information.

Continuing with FIG. 1, computing cluster 102, compute nodes 108, and manager node 104 may include any suitable combination of hardware, firmware, and software, which may cooperate to provide the features of computing system 100. Additionally, where appropriate, each of computing cluster 102, compute nodes 108, and manager node 104 may include one or more computer systems at one or more locations. Each computer system may include any appropriate input devices, output devices, mass storage media, processors, memory, or other suitable components for receiving, processing, storing, and communicating data. Although illustrated and described separately, compute nodes 108 and manager node 104 may be combined or further separated in any suitable manner. For example, these components may be implemented using one or more computing devices at one or more geographic locations. Accordingly, implementations disclosed herein should not be limited to the configuration of components shown in FIG. 1.

Although described primarily in the context of a container cluster orchestration computing environment, this disclosure contemplates the features described herein being used with any suitable type of computing system. For example, the features described here may be used with any suitable type of computing system in which workloads are scheduled for allocation of computing resources according to some type of consumption constraint as may be presented by a license.

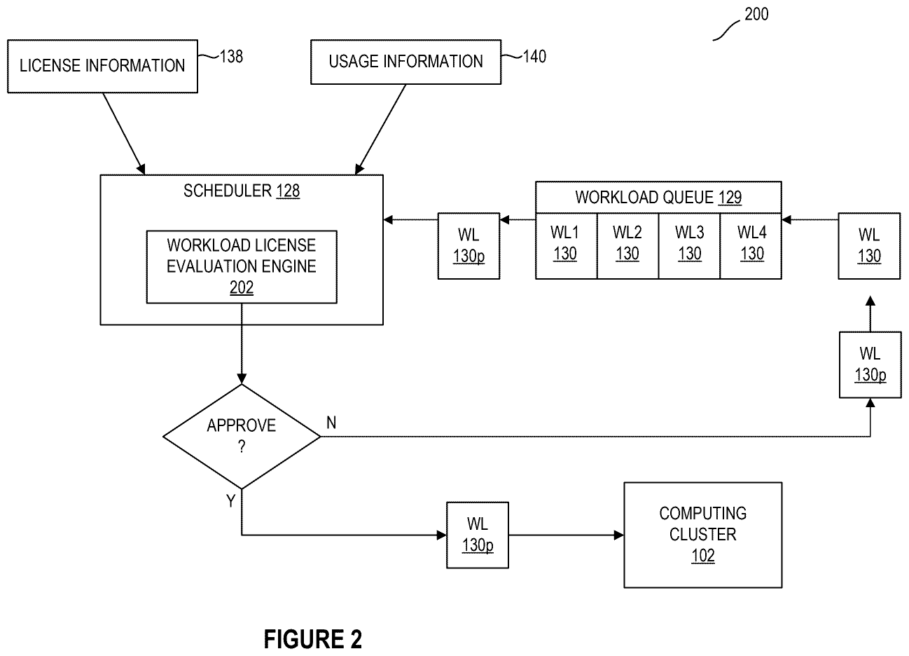

FIG. 2 illustrates an overview 200 of an example workload evaluation process performed by scheduler 128, according to certain implementations. Overview 200 is described with reference to computing system 100, so reference may be made to aspects of computing system 100 even if those elements are not explicitly shown in FIG. 2.

In the illustrated example, scheduler 128 includes workload license evaluation engine 202, which may be implemented using any suitable combination of hardware, firmware, and software. In general, workload license evaluation engine 202 is configured to determine whether to approve or deny scheduling of a workload 130 according to the license constraints associated with a license 136 for the entity associated with the workload 130 and the current resource utilization for the entity associated with the workload 130.

In the illustrated example, workload 130p (abbreviated as WL 130p in FIG. 2) is the workload 130 under consideration for allocation of computing resources 110. Workload 130p is associated with a licensee that may or may not have an adequate license 136 for workload 130p to be allocated computing resources 110, either at all or at this time (depending on current utilization of computing resources 110 for other workloads 130 of the licensee). Scheduler 128 may obtain workload 130p from workload queue 129, which may store pending workloads 130. For example, workload queue 129 may be a first-in, first-out (FIFO) queue, and workload 130p may be the next workload 130 in line. Additionally or alternatively, scheduler 128 may use any suitable algorithm or factors to determine which workload 130 to select from workload queue 129.

To evaluate workload 130p to determine whether to approve or deny scheduling of workload 130p according to the license constraints associated with a license 136, scheduler 128 may obtain certain information that may be used by workload license evaluation engine 202 to perform the evaluation. For example, scheduler 128 may determine the requested computing resources 110 and associated resource amounts from the request and/or workload 130p. As another example, scheduler 128 may obtain selected portions of license information 138 and usage information 140.

Based on the information determined from workload 130p (and/or an associated request to schedule workload 130p), license information 138, and usage information 140, workload license evaluation engine 202 may determine, for the licensee associated with workload 130p, whether scheduling workload 130p would cause total resource usage to exceed the total licensed capacity. Additional details regarding the particular determinations made by scheduler 128 (e.g., workload license evaluation engine 202) are described in greater detail below with reference to FIGS. 3-8.

If workload license evaluation engine 202 determines that the licensee lacks sufficient available computing resources 110 for processing workload 130p (e.g., workload 130p is not approved), then scheduler 128 may return workload 130p to workload queue 129 for reconsideration at a future time. If workload license evaluation engine 202 determines that the licensee has sufficient available computing resources 110 for processing workload 130p (e.g., workload 130p is approved), then scheduler 128 may allocate computing resources 110 to workload 130p and schedule workload 130p for deployment to one or more compute nodes 108 of computing cluster 102.

FIG. 3 illustrates an example method 300 for allocating computing resources 110 to workloads 130, according to certain implementations. Some or all of the operations described with reference to method 300 may be performed by scheduler 128, including potentially workload license evaluation engine 202; however, for ease of description, the operations will be described as being performed by scheduler 128.

At step 302, scheduler 128 may receive a request to schedule a workload 130. Workload 130 may be any suitable type of workload 103 for scheduling an allocation of computing resources (e.g., computing resources 110 of compute nodes 108 of computing cluster 102 in the example of FIG. 1). The request may be associated with an entity that holds one or more licenses 136 in connection with system 100. In certain implementations, scheduler 128 may obtain workload 130 from workload queue 129, which may include pending workloads 130. In certain implementations, receiving a request to schedule a workload 130 includes simply obtaining a workload 130 from a workload queue 129 or other suitable source. To that end, the request and the workload 130 may be used interchangeably.

In certain implementations, the request to schedule workload 130 includes a request to schedule workload 130 for execution using one or more resources of a computer cluster implemented in a cloud computing environment, and the cloud computing environment may include a container orchestration platform.

At step 304, scheduler 128 may determine, in accordance with the request, a resource type and requested resource amount for computing workload 130. The request may include at least one resource type and/or resource amount for computing workload 130. For example, the request may indicate one or more types of computing resources 110 for processing the first computing workload 130 and/or associated resource amounts of the one or more types of computing resources 110 for processing the first computing workload 130.

In certain implementations, scheduler 128 may determine one or more categories for computing workload 130. For example, a workload category may correspond to the resource type determined in accordance with the request. Particular example resource types may include one or more of pCPU, a vCPU, a pGPU, a IoGPU, an amount of storage, and/or any other suitable resource types. As another example, a first workload category may correspond to a particular computing framework, and another workload category may correspond to the resource type determined according to the request.

At step 306, scheduler 128 may obtain a total licensed capacity for the resource type associated with the request. For example, a license 136 for the entity associated with the request may specify a total licensed capacity for the resource type associated with the request. In certain implementations, scheduler 128 may query license management module 132 for the total licensed capacity for the resource type associated with the request. License management module 132 may in turn obtain that information (e.g., from storage device 134) and return the total licensed capacity for the resource type to scheduler 128. Additionally or alternatively, scheduler 128 may simply obtain license information 138 from license management module 132 or directly from storage device 134, and license information 138 may include the total licensed capacity for the resource type.

As described above with reference to step 304, scheduler 128 may determine one or more categories for computing workload 130. The total licensed capacity and current resource usage determined at step 306 may be specific to the one or more categories for computing workload 130. As an example, a first workload category may correspond to a particular computing framework, and another workload category may correspond to the resource type determined according to the request. In certain implementations, and continuing with this example, the total licensed capacity for the resource type may be specific to the resource type of the particular computing framework.

At step 308, scheduler 128 may obtain current resource usage across existing computing workloads for the resource type associated with the request. For example, a licensee associated with the request to schedule workload 130 may have zero, one, or multiple workloads 130 running in cluster 102 that have been allocated computing resources 110. Scheduler 128 may obtain information indicating current resource usage (e.g., of computing resources 110 of compute nodes 108 of computing cluster 102) across existing computing workloads 130 for the resource type associated with the request. In certain implementations, scheduler 128 may query monitoring module 133 for the current resource usage across existing computing workloads for the resource type associated with the request. Monitoring module 133 may in turn obtain that information (e.g., from usage information 140 of storage device 134) and return current resource usage across existing computing workloads for the resource type associated with the request to scheduler 128. Additionally or alternatively, scheduler 128 may simply obtain some or all of usage information 140 from monitoring module 133 or directly from storage device 134, and usage information 140 may include the current resource usage across existing computing workloads for the resource type associated with the request.

At step 310, scheduler 128 may determine whether scheduling workload 130 associated with the request would cause total resource usage to exceed the total licensed capacity. For example, scheduler 128 may add the requested resource amount for the workload 130 associated with the request (e.g., as determined at step 304) to the total current resource usage across existing workloads 130 for the resource type (associated with the workload of the request), and determine whether the sum exceeds the total licensed capacity for the resource type determined at step 306. In certain implementations, for GPU computing resources, and/or similarly for other computing resources that may be partitioned, the total licensed capacity may be based on a number of licensed pGPUs, the current resource usage may be based on fractional (e.g., partitioned) GPU usage across workloads, and determining whether scheduling computing workload 130 would cause total resource usage to exceed the total licensed capacity includes converting the fractional GPU usage to an equivalent number of physical GPUs.

If scheduler 128 determines at step 310 that scheduling workload 130 associated with the request would cause the total resource usage to exceed the total licensed capacity, then at step 312, scheduler 128 may deny the request to schedule workload 130 and place workload 130 in a pending state. For example, scheduler 128 may place workload 130 in a pending workload queue 129, which, if workload 130 originally was pulled from workload queue 129, may include returning workload 130 to workload queue 129.

If scheduler 128 determines at step 310 that scheduling workload 130 associated with the request would not cause the total resource usage to exceed the total licensed capacity, then at step 314, scheduler 128 may approve, based at least on determining that the total resource usage would not exceed the total licensed capacity, the first computing workload 130 for scheduling.

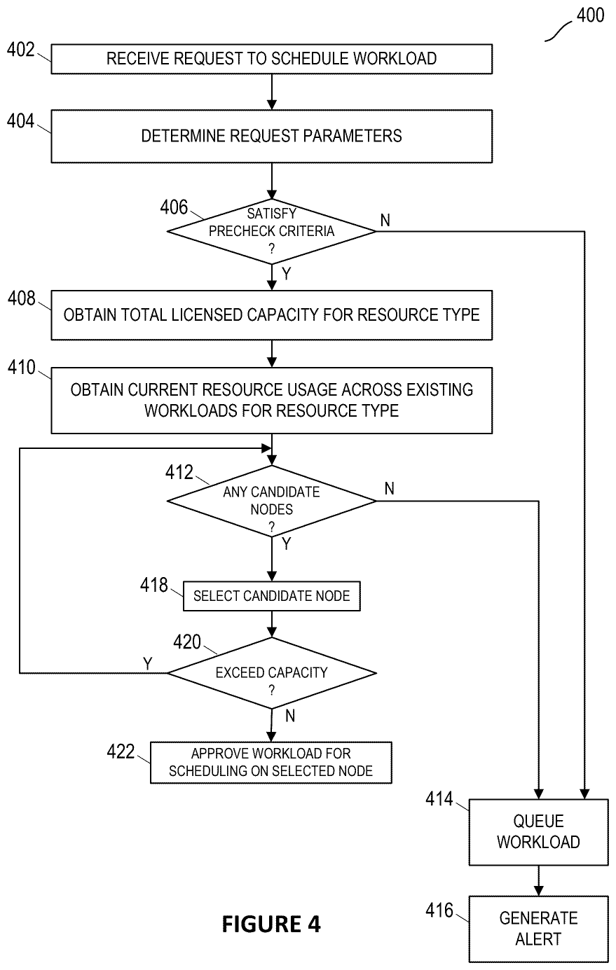

FIG. 4 illustrates an example method 400 for allocating computing resources 110 to workloads 130, according to certain implementations. Some or all of the operations described with reference to method 400 may be performed by scheduler 128, including potentially workload license evaluation engine 202; however, for ease of description, the operations will be described as being performed by scheduler 128.

At step 402, scheduler 128 may receive a request to schedule a workload 130. The workload 130 may be any suitable type of workload 103 for scheduling an allocation of computing resources (e.g., computing resources 110 of compute nodes 108 of computing cluster 102 in the example of FIG. 1). The request may be associated with an entity that holds one or more licenses 136 in connection with system 100. In certain implementations, scheduler 128 may obtain workload 130 from workload queue 129, which may include pending workloads 130. In certain implementations, receiving a request to schedule a workload 130 includes simply obtaining a workload 130 from a workload queue 129 or other suitable source. To that end, the request and the workload 130 may be used interchangeably.

At step 404, scheduler 128 may determine, in accordance with the request, one or more parameters of workload 130. In certain implementations, the one or more parameters may include a resource type and requested resource amount for workload 130, but also may include one or more other types of parameters, some of which may correlate to one or more license term categories. The request may include at least one resource type and/or resource amount for workload 130. For example, the request may indicate one or more types of computing resources 110 for processing the workload 130 and/or associated resource amounts of the one or more types of computing resources 110 for processing workload 130.

At step 406 scheduler 128 may determine whether precheck criteria are met. In certain implementations, obtaining total licensed capacity for a resource type and obtaining current resource usage across existing workloads for the resource type (as will be performed at steps 408 and 410 below) are a relatively expensive computational step. Thus, it may be appropriate to perform certain relatively inexpensive computational prechecks for request to determine whether allocating resources to the workload 130 associated with the request is even possible. For example, the precheck criteria may include determining whether the entity associated with the request holds an active license for the type of computing resource associated with the request. In certain implementations, scheduler 128 may query license management module 132 to determine whether the entity associated with the request holds an active license for the type of computing resource associated with the request. License management module 132 may consult licenses 136 and/or license information 138 in storage device 134 to determine whether the entity associated with the request holds an active license for the type of computing resource associated with the request, and may return a result to scheduler 128.

Other possible precheck criteria may include determining whether workload 130 includes certain computing resource limits (e.g., CPU limits) and determining whether workload 130 includes a user or vendor label (e.g., in annotations of a container or pod of the workload 130), either or both of which may be restrictions enforced in certain implementations. In general, this disclosure contemplates determining whether the request satisfies any suitable type of precheck criteria that may help filter requests prior to performing the relatively expensive computational steps of obtaining total licensed capacity for a resource type and obtaining current resource usage across existing workloads for the resource type (as will be performed at steps 408 and 410 below).

In some implementations, prior to application of the license evaluation process, the set of candidate compute nodes 108 under consideration may be prefiltered by scheduler 128 to identify a set of candidate compute nodes 108 that could process workload 130 according to other factors that scheduler 128 may be considering in addition to licensing constraints. In some scenarios, scheduler 128 may determine that insufficient computing resources 110 are available to processing workload 130 (e.g., at a Filter stage in a KUBERNETES example), and so scheduler 128 may deny scheduling of workload 130 even before reaching the licensing determination (e.g., a Permit phase in a KUBERNETES example).

If scheduler 128 determines at step 406 that the precheck criteria are not met, then method 400 may proceed to step 414, described below following a “no” decision for step 412. If scheduler 128 determines at step 406 that the precheck criteria are met, then method 400 may proceed to step 408.

At step 408, scheduler 128 may obtain a total licensed capacity for the resource type associated with the request. For example, a license 136 for the entity associated with the request may specify a total licensed capacity for the resource type associated with the request. In certain implementations, scheduler 128 may query license management module 132 for the total licensed capacity for the resource type associated with the request. License management module 132 may in turn obtain that information (e.g., from storage device 134) and return the total licensed capacity for the resource type to scheduler 128. Additionally or alternatively, scheduler 128 may simply obtain license information 138 from license management module 132 or directly from storage device 134, and license information 138 may include the total licensed capacity for the resource type.

In certain implementations, the request to schedule workload 130 may include requests for multiple categories of computing resources 110. As described above, licenses 136, according to certain implementations of this disclosure, may provide an ability to license computing resources 110 across multiple different categories and/or subcategories, with potentially different licensing terms (e.g., rates and/or capacities) applying to each category and/or subcategory. Those categories and/or subcategories may include one or more of resource types, frameworks, applications, vendors, and/or any other suitable types of categories/subcategories, potentially in combination, along with appropriate corresponding resource amounts.

In certain implementations, obtaining the total licensed capacity for the types of computing resources 110 at step 408 may include scheduler obtain multiple types of computing resources 110 to be allocated to workload 130 for processing workload 130, according to the categories and/or subcategories associated with the request to schedule workload 130 and the license terms that apply to a license 136 for the entity that associated with the request. For example, the request to schedule workload 130 may include requests for multiple types of computing resources 110 to be allocated to workload 130 for processing workload 130. For example, the request may include requests for a certain amount of vCPU resources and a certain amount of IoGPU resources to be allocated to workload 130 for processing workload 130. Thus, obtaining a total licensed capacity for the resource type associated with the request may include obtaining a total licenses capacity for multiple types of computing resource 110.

At step 410, scheduler 128 may obtain current resource usage across existing computing workloads for the one or more resource types associated with the request. For example, a licensee associated with the request to schedule workload 130 may have zero, one, or multiple workloads 130 running in cluster 102 that have been allocated computing resources 110. Scheduler 128 may obtain information indicating current resource usage (e.g., of computing resources 110 of compute nodes 108 of computing cluster 102) across existing computing workloads 130 for the resource type associated with the request. In certain implementations, scheduler 128 may query monitoring module 133 for the current resource usage across existing computing workloads for the resource type associated with the request. Monitoring module 133 may in turn obtain that information (e.g., from usage information 140 of storage device 134) and return current resource usage across existing computing workloads for the resource type associated with the request to scheduler 128. Additionally or alternatively, scheduler 128 may simply obtain some or all of usage information 140 from monitoring module 133 or directly from storage device 134, and usage information 140 may include the current resource usage across existing computing workloads for the resource type associated with the request.

At step 412, based on request parameters and the current resource usage across existing workloads for the one or more resources types of the request, scheduler 128 may determine whether any candidate compute nodes 108 exist that could accommodate workload 130 according to the parameters determined from the request. For example, scheduler 128 may determine whether any compute nodes 108 exist that have sufficient computing resources 110 to handle the resource amounts for workload 130. Filtering the compute nodes 108 under consideration as candidate compute nodes for allocation to workload 130 may reduce processing at later steps for evaluating whether using computing resources 110 from those compute nodes 108 will fit within license constraints established by the license 136 associated with workload 130. If this is the second or subsequent pass through the determination at step 412 (see step 420), then at step 412 scheduler 128 may be determining whether another candidate compute node 108 exists.

If scheduler 128 determines at step 412 that no candidate compute nodes 108 exist, then method 400 may proceed to step 414. At step 414, scheduler 128 may deny the request to schedule workload 130 and place workload 130 in a pending state. For example, scheduler 128 may place workload 130 in a pending workload queue 129, which, if workload 130 originally was pulled from workload queue 129, may include returning workload 130 to workload queue 129. At step 416, scheduler 128 may generate an alert, which may be logged by manager node 104, made available in manager interface 142, and/or sent to a system administrator or other suitable entity.

Returning to step 412, if scheduler 128 determines at step 412 that one or more candidate compute nodes 108 exist, then at step 418, scheduler 128 may select a compute node 108 to be a candidate for evaluation of whether allocating computing resources 110 from that candidate compute node 108 to workload 130 would fit within the license constraints of a license 136 associated with workload 130. Scheduler 128 may select a candidate compute node 108 for consideration in any suitable manner and according to any suitable criteria. To the extent scheduler 128 cycles through multiple candidate compute nodes 108 to attempt to identify a compute node 108 that can be allocated to workload 130 in a way that complies with license constraints of a license 136 associated with workload 130 (e.g., see steps 412, 418, and 420), then scheduler 128 may mark rejected candidate compute nodes 108 as considered so that the rejected candidate compute nodes 108 are not again selected at step 418 during the current evaluation of workload 130.

At step 420, scheduler 128 may determine whether scheduling workload 130 associated with the request using computing resources 110 of the candidate compute node 108 selected at step 418 would cause total resource usage to exceed the total licensed capacity. For example, scheduler 128 may add the requested resource amount for the workload 130 associated with the request (e.g., as determined at step 404) to the total current resource usage across existing workloads 130 for the resource type (associated with the workload 130 of the request), and determine whether the sum exceeds the total licensed capacity for the resource type determined at step 404. Scheduler 128 may perform the determination at step 420 for each resource type and/or category that is subject to a license constraint.

If scheduler 128 determines at step 420 that scheduling workload 130 associated with the request would cause the total resource usage to exceed the total licensed capacity, then method 400 may return to step 412 for scheduler 128 to determine whether any additional candidate compute nodes 108 exists. If scheduler 128 determines at step 420 that scheduling workload 130 associated with the request would not cause the total resource usage to exceed the total licensed capacity, then at step 422, scheduler 128 may approve, based at least on determining that the total resource usage would not exceed the total licensed capacity, the first computing workload 130 for scheduling using computing resources 110 of the candidate compute node 108 currently under consideration.

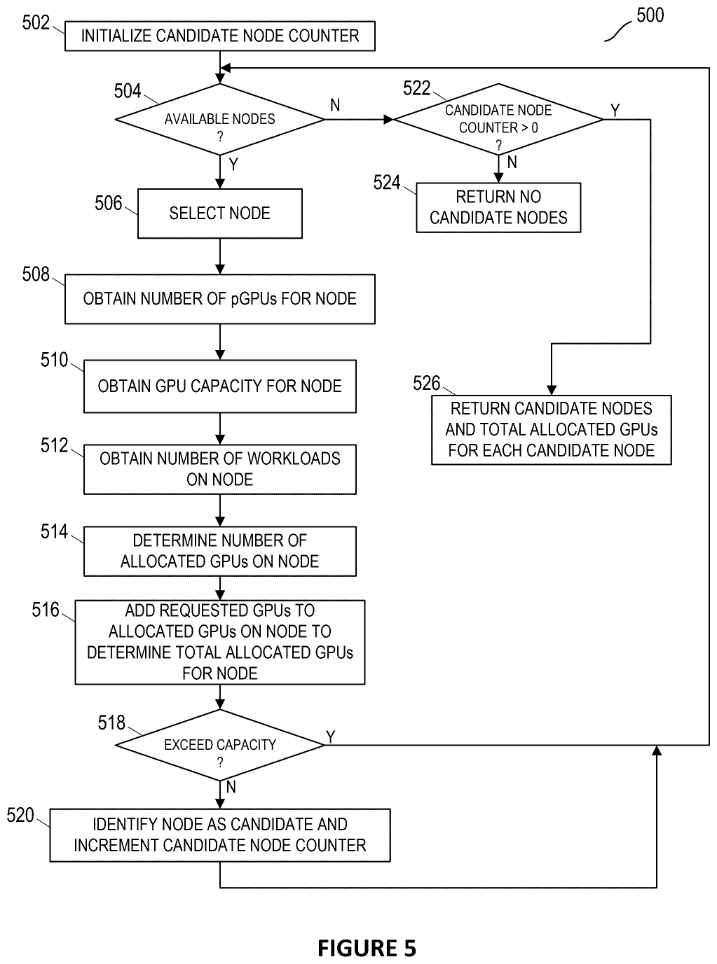

FIG. 5 illustrates an example method 500 for identifying candidate compute nodes 108 and determining associated computing resource allocation amounts, according to certain implementations. Some or all of the operations described with reference to method 500 may be performed by scheduler 128, including potentially workload license evaluation engine 202; however, for ease of description, the operations will be described as being performed by scheduler 128. Method 500 may provide an example technique for performing step 412 of method 400 of FIG. 4. Additionally, method 500 is described using GPU devices as an example of the computing resources 110 that are the subject of a workload request. It should be understood, however, that scheduler 128 may perform method 500 for any suitable type of computing resource 110. A candidate node may refer to a compute node 108 that has sufficient computing resources 110 to process workload 130, but that might or might not be a good fit in view of license constraints.

At step 502, scheduler 128 may initialize a node counter. In certain implementations, initializing the candidate node counter includes setting the candidate node counter to zero, as no candidate nodes have been identified.

At step 504, scheduler 128 may determine whether any compute nodes 108 are available. This determination may be a relatively simple determination of whether any compute nodes 108 are up and running in cluster 102. If scheduler determines at step 504 that no (or no more if on a second or subsequent pass) compute nodes 108 are available, then method 500 may proceed to step 522, described below. If, on the other hand, scheduler 128 determines at step 504 that one or more compute nodes 108 are available, then method 500 may proceed to step 506.

At step 506, scheduler 128 may select a particular compute node 108 from the available compute nodes 108. At step 508, scheduler 128 may obtain the number of physical GPUs for the selected compute node 108. Scheduler 128 may obtain the number of physical GPUs for the selected compute node 108 according to usage information 140.

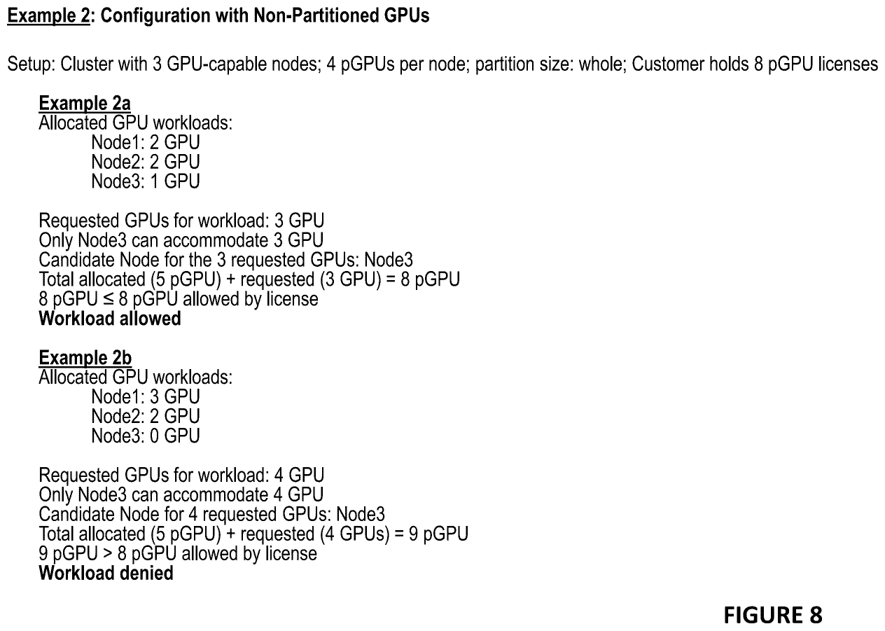

At step 510, scheduler 128 may obtain the GPU capacity for the selected compute node 108. In some examples, partitioning of GPUs is available, in which case the GPU capacity available to workloads may be greater than the number of physical GPUs. FIG. 7, described below, provides an example in which partitioning of physical GPUs is permitted. In some examples, the GPU capacity may be the same as the number of physical GPUs, such as when no partitioning of physical GPUs is available. FIG. 8, described below, provides an example in which no partitioning of GPUs is available.

At step 512, scheduler 128 may obtain the number of workloads 130 on the selected compute node 108. That is, scheduler 128 may determine the number of workloads 130 that already are running on the selected compute node 108. These workloads might or might not be associated with the entity associated with the workload 130 under evaluation for scheduling. Scheduler 128 may obtain the number of workloads 130 that already are running on the selected compute node 108 according to usage information 140.

At step 514, scheduler 128 may determine the number of allocated GPUs on the selected compute node 108. In an example in which the GPU capacity is the same as the number of physical GPUs (e.g., when no partitioning of physical GPUs is available), the number of allocated GPUs may be equal to the number of workloads 130 determined at step 512. In an example in which partitioning of GPUs is available, the number of allocated GPUs on the selected compute node may be determined by dividing the number of workloads 130 on the selected compute node 108 (as determined at step 512) by the GPU capacity for the selected compute node 108 (as determined at step 510).

At step 516, scheduler 128 may add the number requested GPUs to the allocated GPUs on the selected compute node 108 to determine a total allocated GPUs for the selected compute node 108. In an example in which the GPU capacity is the same as the number of physical GPUs (e.g., when no partitioning of physical GPUs is available), the number of requested GPUs may simply be added to the number of allocated GPUs on the selected compute node 108. In an example in which partitioning of GPUs is available, the number of requested GPUs may be divided by the GPU capacity for the selected compute node 108 (as determined at step 510), and then the quotient may be added to the number of allocated GPUs on the selected compute node determined at step 514.

At step 518, scheduler 128 may determine whether the allocated GPUs for the selected compute node 108 plus the requested GPUs for the selected compute node 108 (a sum determined at step 516) exceed the capacity of the selected compute node 108 (as determined at step 510). If scheduler 128 determines at step 518 that capacity is exceeded, then method 500 may return to step 504 to determine whether there are any more available compute nodes 108. If, at step 518, scheduler 128 determines that capacity is not exceeded, then method 500 may proceed to step 520.

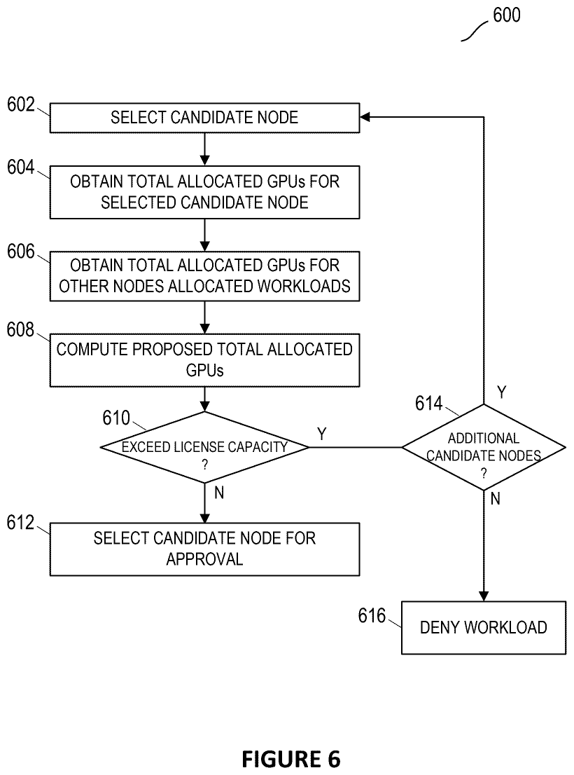

At step 520, scheduler 128 may identify the selected compute node 108 as a candidate compute node 108 and may increment the candidate node counter by 1. In association with identifying the selected compute node 108 as a candidate compute node 108, scheduler 128 also may note the total allocated GPUs for the selected compute node 108 calculated at step 516 for use in evaluating whether allocating the GPU resources of the candidate compute node 108 to workload 130 would comply with the license constraints of the license 136 associated with workload 130 (see FIG. 6, described below). Following step 520, scheduler 128 may return to step 504 to determine whether there are any more available compute nodes 108.

Returning to step 504, either initially or following step 518 or step 520, if scheduler 128 determines a step 504 that there are no available compute nodes 108 (on an initial pass of method 500) or no more available compute nodes 108 (on a second or subsequent pass of method 500), then method 500 may proceed to step 522.

At step 522, scheduler 128 may determine whether the candidate node counter is greater than 0. If scheduler 128 determines that step 522 that the candidate node counter is not greater than 0, then method 500 may proceed to step 524. At step 524, scheduler 128 may determine that there are no candidate compute nodes 108 for processing workload 130 and may deny the request to schedule workload 130. If instead at step 522, scheduler 128 determines that the candidate node counter is greater than 0, then method 500 may proceed to step 526. At step 526, scheduler 128 may return the list of candidate compute nodes 108 and the total allocated GPU for each candidate compute node 108.

FIG. 6 illustrates an example method 600 for evaluating allocated and requested resource usage for one or more compute nodes 108, according to certain implementations. Some or all of the operations described with reference to method 600 may be performed by scheduler 128, including potentially workload license evaluation engine 202; however, for ease of description, the operations will be described as being performed by scheduler 128. Method 600 may provide an example technique for performing steps 310-314 of method 300 of FIG. 3 and/or steps 418-422 of method 400 of FIG. 4. Additionally, method 600 is described using GPU devices as an example of the computing resources 110 that are the subject of a workload request. It should be understood, however, that scheduler 128 may perform method 600 for any suitable type of computing resource 110.

At step 602, scheduler 128 may select a particular candidate compute node 108 from the possible candidate compute nodes 108 determined according to method 500 of FIG. 5. At step 604, scheduler 128 may obtain the total allocated GPUs for the selected candidate node 108. For example, for the selected candidate node 108, the total allocated GPUs may be the value determined at step 516 of method 500 of FIG. 5.

Continuing with method 600 of FIG. 6, at step 606, scheduler 128 may obtain the total allocated GPUs for other nodes 108 that are allocated workloads 130 for the licensee associated with workload 130. For example, because method 600 attempts to determine whether the licensee associated with workload 130 can deploy workload 130 in a manner that complies with a license 136 of the licensee, then step 606 may determine the total allocated GPUs for other nodes 108 that are allocated workloads 130 for the licensee associated with workload 130.

At step 608, scheduler 128 may compute a proposed total allocated GPU. The proposed total allocated GPU may be a sum of the number determined at step 604 and the number determined at step 606.

At step 610, scheduler 128 may determine whether the license capacity is exceeded. In particular, scheduler 128 may determine whether the license capacity for GPUs for the licensee associated with workload 130 is exceeded using the selected candidate node 108 and the proposed total allocated GPU number determined at step 608.

If scheduler 128 determines at step 610 that the license capacity is not exceeded, then at step 612, scheduler 128 may select the candidate node 108 for approval for processing the workload 130. Returning to step 610, if scheduler 128 determines at step 610 that the license capacity is exceeded, then at step 614, scheduler 128 may determine whether there are additional candidate nodes 108. If scheduler 128 determines at step 614 that there are additional candidate nodes 108, then method 600 may return to step 602 to select a new candidate compute node 108. If, on the other hand, scheduler 128 determines at step 614 that there are no additional candidate nodes 108, then method 600 may proceed to step 616. At step 616, scheduler 128 may determine that the workload 130 should be denied.

Although method 600 of FIG. 6 is described with respect to a particular type of resource, namely GPUs, it should be understood that method 600 may be repeated for any suitable number of types of computing resources 110 and/or other license categories that a license 136 for the licensee associated with workload 130 may address.

FIGS. 7 through 8 illustrate example computing resource allocation scenarios and associated example license considerations, according to certain implementations. This disclosure includes these specific, potentially simplified, examples merely to facilitate understanding certain implementations of this disclosure. These examples do not limit the scope of this disclosure.

FIG. 7 illustrates an example computing resource allocation scenario and associated example license considerations, according to certain implementations. The example scenario illustrated in FIG. 7 will be referred to as Example 1, and provides an example configuration in which GPU partitioning is permitted.

In Example 1, a computing system includes three GPU-capable compute nodes, and each of the three GPU-capable compute nodes has one pGPU. The computing system is configured with the following GPU partition capacity per node: the one pGPU of Node1 is split into seven GPU partitions, the one pGPU of Node2 is split into four GPU partitions, and the one pGPU of Node3 is split into four GPU partitions. Additionally, the partition size for this arrangement is considered small. For purposes of these examples it will be assumed that partition sizes can be small, medium, large, or whole (whole meaning the entire pGPU is not split into smaller partitions). Continuing with Example 1, the licensee has 2 pGPU licenses total.

The current state of the computing system includes certain allocated workloads that are consuming some of the licensee's GPU capacity. For example, Node1 has GPU workloads that are consuming 4 GPUs, which is 0.57 of the pGPUs for Node1. This is because Node1 has one pGPU that has been split into seven GPU partitions, and four divided by seven equals 0.57. As another example, Node2 has GPU workloads that are consuming 2 GPUs, which is 0.5 of the pGPUs for Node2. This is because Node2 has one pGPU that has been split into four GPU partitions, and two divided by four equals 0.5. As another example, Node3 has GPU workloads that are consuming 1 GPU, which is 0.25 of the pGPUs for Node3. This is because Node3 has one pGPU that has been split into four GPU partitions, and one divided by four equals 0.25.

Continuing with Example 1, the licensee may launch a new workload that requests three GPUs. In this example, only two of the three compute nodes have sufficient available GPUs to accommodate the requested 3 GPUs of the new workload, Node1 and Node3, as 2 of the 4 GPUs (GPU partitions) of Node2 already have been allocated (leaving only 2 GPU partitions available with Node2). As described above, the licensee only has two pGPU licenses, so depending on which compute node (as between possible Node1 and Node3) the scheduler selects, the licensee might or might not have enough licenses to launch the new workload. For example, Node3 might be selected as only 1 of the 4 GPU partitions has been allocated; however, using the three available GPU partitions of Node3 would cause the licensee to exceed its licensed capacity of two pGPUs. In particular, using the three available GPU partitions of Node3 would bring the pGPU usage for Node3 to 1. Adding the pGPU usage of all three compute nodes, would bring the total pGPU usage to 2.07, which is greater than the licensee's licensed capacity of 2, meaning the requested workload would be denied in this scenario.

To illustrate, the following calculations may be performed. First, the total allocated pGPUs on the selected compute node under consideration (Node3 in this example) may be determined. In this example, the calculation is 0.25 (that is, the number of GPU partitions already allocated as a proportion of the total number of GPU partitions for this compute node, Node3) plus 0.75 (that is, the number of requested GPUs as a proportion of the total number of GPU partitions for this compute node, Node3), which equals 1 pGPU (the entire one pGPU of Node3). Using the formula Total Allocated pGPUs+total requested pGPUs to determine the total pGPUs needed, the total pGPUs needed would be 2.07, which exceeds the licensee's licensed capacity of 2 pGPUs.

Performing similar calculations using Node1 as the selected compute node, the three requested GPUs would be 0.43 of the pGPU of Node1 (three of the seven GPU partitions of Node1 (3/7=0.43)). Adding the 0.43 pGPUs for the requested workload to the 0.57 pGPUs already allocated from Node1 results in 1 pGPU. Adding the total allocated pGPUs for the other nodes to the 1 pGPU for Node1 results in 1.75 (1 (for selected Node1, as adjusted for the requested 3 IoGPUs)+0.5 (for Node2)+0.25 (for Node3), which totals 1.75). This total (1.75) is less than the two licensed pGPUs for the licensee, so the workload can be scheduled using three IoGPUs of Node1.

FIG. 8 illustrates example computing resource allocation scenarios and associated example license considerations, according to certain implementations. The example scenarios illustrated in FIG. 8 will be referred to as Example 2, and includes Examples 2a and 2b. Example 2 provides example configurations in which GPU partitioning is not permitted.

In Example 2 (both Example 2a and Example 2b), a computing system includes three GPU-capable compute nodes, and each of the three GPU-capable compute nodes includes 4 pGPUs. The computing system is configured such that the partition size is whole, meaning that the pGPUs of each compute node are not partitioned into GPUs and are allocated as an entire pGPU. In Example 2 (both Example 2a and Example 2b, described below), the licensee has 8 pGPU licenses total.

In Example 2a, the current state of the computing system includes certain allocated workloads that are consuming some of the licensee's GPU capacity. For example, Node1 has GPU workloads that are consuming 2 of the 4 pGPUs for Node1, Node2 has GPU workloads that are consuming 2 of the 4 pGPUs, and Node3 has GPU workloads that are consuming 1 of the 4 pGPUs.

Continuing with Example 2a, the licensee may launch a new workload that requests three GPUs, and because it is not possible to request GPU partitions under the system in Example 2 (e.g., the partition size is whole), this request is for 3 pGPUs. In this example, only one of the three compute nodes has sufficient available pGPUs to accommodate the requested 3 GPUs of the new workload, Node3, as 2 of the 4 pGPUs of Node1 and 2 of the 4 pGPUs of Node2 already have been allocated (leaving only 2 pGPUs available with each of Nodes 1 and 2). As described above, the licensee has eight pGPU licenses, so taking Node3 as the candidate compute node for the three requested pGPUs and adding the three requested pGPUs to the 1 pGPU of Node3, Node3 would have 4 pGPUs allocated. Adding the pGPU usage of all three compute nodes would bring the total pGPU usage to 8 pGPU, which is less than or equal to (is equal to) the licensee's licensed capacity of 8 pGPU, meaning the requested workload would be allowed in this scenario.

To illustrate, the following calculations may be performed. First, the total allocated pGPUs on the selected compute node under consideration (Node3 in this example) may be determined. In this example, the calculation is 1 pGPU (that is, the number of pGPUs already allocated, 1 pGPU) plus 3 pGPU (that is, the number of requested pGPUs), which equals 4 pGPUs. Using the formula Total Allocated pGPUs+total requested pGPUs to determine the total pGPUs needed, the total pGPUs needed would be 8, which is less than or equal to (is equal to) the licensee's licensed capacity of 8 pGPU, meaning the requested workload would be allowed in this scenario.

In Example 2b, the current state of the computing system includes certain allocated workloads that are consuming some of the licensee's GPU capacity. For example, Node1 has GPU workloads that are consuming 3 of the 4 pGPUs for Node1, and Node2 has GPU workloads that are consuming 2 of the 4 pGPUs. Node3, however, has no GPU workloads that are consuming any the 4 pGPUs of Node3.

Continuing with Example 2b, the licensee may launch a new workload that requests four GPUs, and because it is not possible to request GPU partitions under the system in Example 2 (e.g., the partition size is whole), this request is for 4 pGPUs. In this example, only one of the three compute nodes has sufficient available pGPUs to accommodate the requested 4 GPUs of the new workload, Node3, as 3 of the 4 pGPUs of Node1 and 2 of the 4 pGPUs of Node2 already have been allocated (leaving only 1 pGPU available for Node1 and only 2 pGPUs available for Node2). As described above, the licensee has eight pGPU licenses, so taking Node3 as the candidate compute node for the four requested pGPUs and adding the four requested pGPUs to the 0 pGPU of Node3, Node3 would have 4 pGPUs allocated. Adding the pGPU usage of all three compute nodes would bring the total pGPU usage to 9 pGPU, which exceeds the licensee's licensed capacity of 8 pGPU, meaning the requested workload would be denied in this scenario.

To illustrate, the following calculations may be performed. First, the total allocated pGPUs on the selected compute node under consideration (Node3 in this example) may be determined. In this example, the calculation is 0 pGPU (that is, the number of pGPUs already allocated) plus 4 pGPU (that is, the number of requested pGPUs), which equals 4 pGPUs. Using the formula Total Allocated pGPUs+total requested pGPUs to determine the total pGPUs needed, the total pGPUs needed would be 9, which exceeds the licensee's licensed capacity of 8 pGPU, meaning the requested workload would be denied in this scenario.

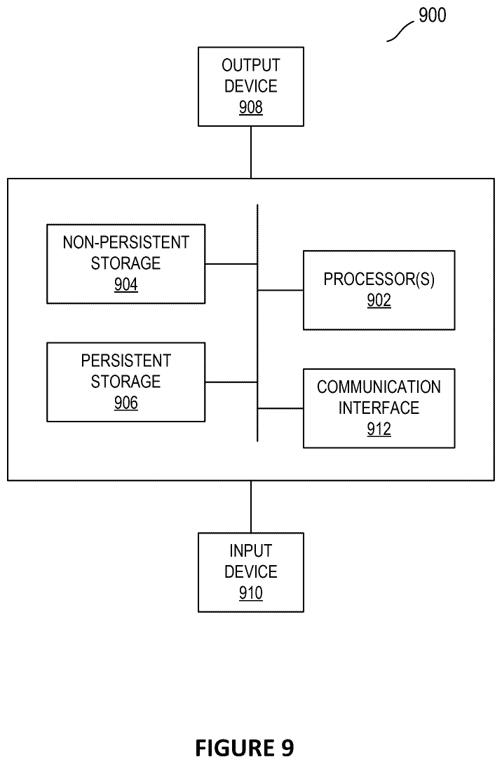

FIG. 9 illustrates a block diagram of an example computing device 900, according to certain implementations. As discussed above, implementations of this disclosure may be implemented using computing devices. For example, all or any portion of the components or methods shown in FIGS. 1-8 (e.g., system 100, computing cluster 102, manager node 104, compute nodes 108, and methods 300, 400, 500, 600, and 700) may be implemented, at least in part, using one or more computing devices such as computing device 900.

Computing device 900 may include one or more computer processors 902, non-persistent storage 904 (e.g., volatile memory, such as RAM, cache memory, etc.), persistent storage 906 (e.g., a hard disk, an optical drive such as a compact disk (CD) drive or digital versatile disk (DVD) drive, a flash memory, etc.), a communication interface 912 (e.g., Bluetooth interface, infrared interface, network interface, optical interface, etc.), input devices 910, output devices 908, and numerous other elements and functionalities. Each of these components is described below.

In certain implementations, computer processor(s) 902 may be an integrated circuit for processing instructions. For example, computer processor(s) may be one or more cores or micro-cores of a processor. Processor 902 may be a general-purpose processor configured to execute program code included in software executing on computing device 900. Processor 902 may be a special purpose processor where certain instructions are incorporated into the processor design. Although only one processor 902 is shown in FIG. 9, computing device 900 may include any number of processors.

Computing device 900 may also include one or more input devices 910, such as a touchscreen, keyboard, mouse, microphone, touchpad, electronic pen, motion sensor, or any other type of input device. Input devices 910 may allow a user to interact with computing device 900. In certain implementations, computing device 900 may include one or more output devices 908, such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to computer processor(s) 902, non-persistent storage 904, and persistent storage 906. Many different types of computing devices exist, and the aforementioned input and output device(s) may take other forms. In some instances, multimodal systems can allow a user to provide multiple types of input/output to communicate with computing device 900.

Further, communication interface 912 may facilitate connecting computing device 900 to a network (e.g., a LAN, WAN) such as the Internet, mobile network, or any other type of network) and/or to another device, such as another computing device. Communication interface 912 may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a Bluetooth® wireless signal transfer, a Bluetooth® Low Energy (BLE) wireless signal transfer, an IBEACON® wireless signal transfer, a radio frequency identifier (RFID) wireless signal transfer, near-field communications (NFC) wireless signal transfer, dedicated short range communication (DSRC) wireless signal transfer, 802.11 Wi-Fi wireless signal transfer, WLAN signal transfer, Visible Light Communication (VLC), Worldwide Interoperability for Microwave Access (WiMAX), IR communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 912 may also include one or more Global Navigation Satellite System (GNSS) receivers or transceivers that are used to determine a location of the computing device 900 based on receipt of one or more signals from one or more satellites associated with one or more GNSS systems. GNSS systems include, but are not limited to, the US-based global positioning system (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

The term computer-readable medium includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as CD or DVD, flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

All or any portion of the components of computing device 900 may be implemented in circuitry. For example, the components can include and/or be implemented using electronic circuits or other electronic hardware, which can include one or more programmable electronic circuits (e.g., microprocessors, graphics processing units (GPUs), digital signal processors (DSPs), CPUs, and/or other suitable electronic circuits), and/or can include and/or be implemented using computer software, firmware, or any combination thereof, to perform the various described operations. In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Certain implementations of this disclosure may provide some, none, or all of the following technical advantages. In certain implementations, the disclosure may offer more efficient resource utilization. For example, by tying licenses to actual workload usage rather than total infrastructure capacity, organizations might be able to optimize their license purchases, potentially reducing costs. This approach may allow customers to pay for the resources they actively use, reducing or eliminating payment for idle or overhead capacity.

Certain implementations may provide greater flexibility for customers. For example, the system may allow workloads to be queued when license capacity is reached, rather than outright rejecting the workloads. This approach may allow organizations to manage peak usage periods more effectively while potentially avoiding over-provisioning licenses.

Certain implementations may offer more granular control over licensing. For example, certain implementations may allow for different categories of workloads or resources to be licensed separately and/or differently. This capability might allow more tailored licensing models that better align with an organization's specific usage patterns and goals.

Certain implementations may provide real-time visibility into license usage. For example, by dynamically tracking resource consumption across workloads, organizations might gain deeper insights into their licensing goals and usage patterns. This information can potentially help in making more informed decisions about license purchases and resource allocation.

Certain implementations may provide advantages in multi-cloud or hybrid cloud environments. For example, by using a custom scheduler that can integrate with container orchestration platforms like KUBERNETES, the system might be able to enforce consistent licensing policies across diverse cloud environments.

In certain implementations, this disclosure can provide more accurate license enforcement for specialized resources. For example, certain implementations provide an ability to handle fractional GPU usage, potentially allowing for more precise licensing of GPU resources, which can be particularly valuable with artificial intelligence and machine learning workloads for which GPU utilization can vary significantly.

Certain implementations may offer benefits to software vendors. For example, by providing more accurate usage data and enforcing licenses more dynamically, vendors might be able to offer more flexible licensing models. This could potentially open up new market opportunities or pricing strategies.

It should be understood that the systems and methods described in this disclosure may be combined in any suitable manner.

Although this disclosure describes or illustrates particular operations as occurring in a particular order, this disclosure contemplates the operations occurring in any suitable order. Moreover, this disclosure contemplates any suitable operations being repeated one or more times in any suitable order. Although this disclosure describes or illustrates particular operations as occurring in sequence, this disclosure contemplates any suitable operations occurring at substantially the same time, where appropriate. Any suitable operation or sequence of operations described or illustrated herein may be interrupted, suspended, or otherwise controlled by another process, such as an operating system or kernel, where appropriate. The acts can operate in an operating system environment or as stand-alone routines occupying all or a substantial part of the system processing.

While this disclosure has been described with reference to illustrative implementations, this description is not intended to be construed in a limiting sense. Various modifications and combinations of the illustrative implementations, as well as other implementations of the disclosure, will be apparent to persons skilled in the art upon reference to the description. It is therefore intended that the appended claims encompass any such modifications or implementations.

What is claimed is:

1. A computing device, comprising:
one or more processors; and
one or more non-transitory computer-readable storage media storing programming for execution by the one or more processors, the programming comprising instructions to:
receive a request to schedule a first computing workload;
determine, in accordance with the request, a resource type and requested resource amount for the first computing workload;
obtain a total licensed capacity for the resource type;
obtain a current resource usage across existing computing workloads for the resource type;
determine whether scheduling the first computing workload would cause total resource usage to exceed the total licensed capacity; and
approve, based at least on determining that the total resource usage would not exceed the total licensed capacity, the first computing workload for scheduling; or
queue, based at least on determining that the total resource usage would exceed the total licensed capacity, the first computing workload for later scheduling.

2. The computing device of claim 1, wherein the programming further comprises instructions to determine a first category for the first computing workload, the first workload category being one of a plurality of categories, the total licensed capacity and current resource usage being determined specific to the first category.

3. The computing device of claim 2, wherein the first category corresponds to the resource type determined in accordance with the request.

4. The computing device of claim 3, wherein the resource type comprises one or more of:
a central processing unit (pCPU);
a virtual CPU (vCPU)
a physical graphic processing unit (pGPU);
a logical graphics processing unit (IoGPU); or
an amount of storage.

5. The computing device of claim 2, wherein the first workload category corresponds to a particular computing framework from among a plurality of possible computing frameworks.

6. The computing device of claim 5, wherein a second workload category corresponds to the resource type determined according to the request, the total licensed capacity for the resource type being specific to the resource type of the particular computing framework.

7. The computing device of claim 1, wherein:
for GPU resources:
the total licensed capacity is based on a number of licensed physical GPUS;
the current resource usage is based on partitioned GPU usage across workloads; and
the instructions to determine whether scheduling the first computing workload would cause total resource usage to exceed the total licensed capacity comprise instructions to converting the partitioned GPU usage to an equivalent number of physical GPUs.

8. The computing device of claim 1, further comprising instructions to determine, prior to obtaining the total licensed capacity for the resource type and obtaining the current resource usage across existing computing workloads for the resource type, that one or more precheck criteria are satisfied, the precheck criteria comprising validating that an active license exists for the resource type associated with the first request.

9. The computing device of claim 1, wherein the request to schedule the first computing workload comprises a request to schedule the computing workload for execution using one or more resources of a computer cluster implemented in a cloud computing environment, the cloud computing environment comprising a container orchestration platform, at least a portion of the one or more resources being of the resource type.

10. The computing device of claim 1, wherein:
prior to receiving a request to schedule a first computing workload, the first computing workload is selected from a pending workload queue; and
the instructions to queue, based at least on determining that the total resource usage would exceed the total licensed capacity, the first computing workload for later scheduling, comprise instructions to return the first computing workload to the pending workload queue.

11. A computer-implemented method, comprising:
receiving, by a computing device, a first request to schedule a first computing workload;
determining, by the computing device and in accordance with the first request, a resource type and requested resource amount for the first computing workload;
obtaining, by the computing device, a total licensed capacity for the resource type;
obtaining, by the computing device, a current resource usage across existing computing workloads for the resource type;
approving, by the computing device based at least on determining that scheduling the first computing workload would not cause total resource usage to exceed the total licensed capacity, the first computing workload for scheduling.

12. The computer-implemented method of claim 11, further comprising:
receiving, by the computing device, a second request to schedule a second computing workload;
determining, by the computing device and in accordance with the second request, a resource type and requested resource amount for the second computing workload;
obtaining, by the computing device, a total licensed capacity for the resource type for the second computing workload;
obtaining, by the computing device, a current resource usage across existing computing workloads for the resource type for the second computing workload; and
queuing, based at least on determining that the total resource usage for the second computing workload would exceed the total licensed capacity for the resource type for the second computing workload, the second computing workload for later scheduling.

13. The computer-implemented method of claim 11, further comprising determining a first category for the first computing workload, the first category being one of a plurality of categories, the total licensed capacity and current resource usage being determined specific to the first category.

14. The computer-implemented method of claim 13, wherein the first category corresponds to the resource type determined in accordance with the request.

15. The computer-implemented method of claim 14, wherein the resource type comprises one or more of:
a central processing unit (pCPU);
a virtual CPU (vCPU)
a physical graphic processing unit (pGPU);
a virtual graphics processing unit (IoGPU); or
an amount of storage.

16. The computer-implemented method of claim 13, wherein the first category corresponds to a particular computing framework from among a plurality of possible computing frameworks.

17. The computer-implemented method of claim 11, wherein:
for GPU resources:
the total licensed capacity is based on a number of licensed physical GPUS;
the current resource usage is based on partitioned GPU usage across workloads; and
determining whether scheduling the first computing workload would cause total resource usage to exceed the total licensed capacity comprise converting the partitioned GPU usage to an equivalent number of physical GPUs.

18. The computer-implemented method of claim 11, further comprising instructions to determine, prior to obtaining the total licensed capacity for the resource type and obtaining the current resource usage across existing computing workloads for the resource type, that one or more precheck criteria are satisfied, the precheck criteria comprising validating that an active license exists for the resource type associated with the first computing workload request.

19. The computer-implemented method of claim 11, wherein:
prior to receiving a request to schedule a first computing workload, the first computing workload is selected from a pending workload queue; and
queuing, based at least on determining that the total resource usage would exceed the total licensed capacity, the first computing workload for later scheduling, comprise instructions to return the first computing workload to the pending workload queue.

20. One or more non-transitory computer-readable storage media storing programming for execution by the one or more processors, the programming comprising instructions to:
receive a request to schedule a first computing workload;
determine, in accordance with the request, a resource type and requested resource amount for the first computing workload;
obtain a total licensed capacity for the resource type;
obtain a current resource usage across existing computing workloads for the resource type;
determine whether scheduling the first computing workload would cause total resource usage to exceed the total licensed capacity; and
approve, based at least on determining that the total resource usage would not exceed the total licensed capacity, the first computing workload for scheduling; or
queue, based at least on determining that the total resource usage would exceed the total licensed capacity, the first computing workload for later scheduling.
